(19) United States
(12) Patent Application Publication
(10) Pub. No.: US 2008/0137666 A1
(43) Pub. Date: Jun. 12, 2008

(54) Cut-through information scheduler

(75) Inventors: Mark Fairhurst, Chorlton (GB); Brendan Francis Durkin, Elland (GB)

Correspondence Address: Gerald W. Maliszewski, P.O. Box 270829, San Diego, CA, 92198-2829, US

(73) Assignee: Applied Micro Circuits Corporation

(21) Appl. No.: 11/634,572

(22) Filed: Dec. 6, 2006

(51) Int. Cl. H04L 12/58

(52) U.S. Cl. 370/395.41

(57) ABSTRACT

A cut-through system and method are provided for scheduling information in an information distribution device. The method receives a plurality of information streams. A master schedule is created to select messages from the information streams for transfer to a corresponding plurality of remote links. The messages (e.g., packets) may have either a fixed or variable length. The master schedule is responsible for managing a communication link overall maximum bandwidth, and a message bandwidth for each remote link. Concurrently, an underrun schedule is created to select segment rates for a first group of messages destined to corresponding first group of remote links, and manage the message segment rate for the first group of messages. For example, the first group of messages may be destined to remote links that are sensitive to underrun.

### BACKGROUND OF THE INVENTION

1. Field of the Invention

This invention generally relates to digital communications and, more particularly, to a system and method for optimizing cut-through information scheduling.

2. Description of the Related Art

As noted in U.S. Pat. No. 7,050,394, communicating over a network often involves a variety of tasks. For example, to send content (e.g., a web-page, e-mail, streaming video, etc.) from one device to another, the content is typically divided into portions carried by different packets. An individual packet includes a payload that stores some portion of the content being sent and a header that includes data used in delivering the packet to its destination. By analogy, the packet's payload is much like a letter being mailed while the header stores information (e.g., a network destination address) that appears on the envelope.

A typical router contains a line card for receiving data packets on one end, performing necessary conversions and sending out the packets at the other end. Among other components, line cards include a framer for framing/de-framing data packets, and a processor for performing protocol conversion and for controlling packet traffic. The framer communicates with the processor using a protocol such as SPI3 or SPI4 (system packet interface), which defines packet and cell transfer standards between a physical layer device (i.e., the framer) and a link layer device (i.e., the processor).

Generally, before transmission, a framer maps one or more packets (or packet portions) into a logical organization of bits known as a frame. In addition to packet data, a frame often includes flags (e.g., start and end of frame flags), a frame checksum that enables a receiver to determine whether transmission errors occurred, and so forth. The framer feeds frame bits to one or more devices that generate signals to be carried over a network connection. For example, for an optic signal, the framer feeds a serializer/deserializer (SERDES) and transceiver that generates optic signals representing the digital data of a frame.

Processing a received frame generally proceeds in the reverse of the process described above. That is, a device physically receives signals over a network connection, determines bit values corresponding to the signals, and passes the bits to a framer. The framer identifies frames within the bit stream and can extract packets stored within the frames.

In network terminology, the components described above perform tasks associated with different layers of a network communication “protocol stack.” For example, the bottom layer, often known as the “physical layer”, handles the physical generation and reception of signals. The “link layer” includes tasks associated with framing. Above the physical and link layers are layers that process packets (the “network layer”) and coordinate communication between end-points (the “transport layer”). Above the transport layer sits the “application layer” that processes the content communicated.

Underrun and overrun are two common problems associated with the framing of data. Overrun involves the sending of too much data, or data at too high of a rate. In this case, data sent to the framer is lost before it can be buffered, which requires that the data be resent. Underrun is associated with sending too little data, or data at too slow of a rate. Some messaging protocols, such as Ethernet, are sensitive to underrun. Ethernet frames are only transmitted if they are “full” of data. Therefore, the transmission of entire Ethernet frames can be delayed as a result of underrun. Conventionally, the use of polling messages, which is a form of handshaking, addresses the overrun problem.

The conventional method of packet routing is called store-and-forward. In this method, a framing device accepts an input packet and buffers the entire packet on the ingress side of the link, knowing the exact number of cells in the packet. The problem with the store-and-forward method is the added latency and memory required to buffer the entire packet. Further, it is difficult to “fairly” serve a multi-channel system if one channel monopolizes the link for the transmission of an entire packet. In cut-through packet routing, a device is able to send the incoming packet cells to the correct egress port as soon as the destination address is known. In a multi-channel system, each remote link can be serviced more often, with smaller sized messages. However, the issue of scheduling transmissions becomes more problematic.

The problem of underrun is conventionally prevented by using significant hardware resources, including options such as dedicated datapath channels from the scheduler to the line interfaces, or large amounts of buffering to store-and-forward packets prior to transmission to the line interfaces. Alternatively, underrun-sensitive interfaces can be assigned a higher priority within a scheduler but this prioritization results in the overall fairness between non-underrun-sensitive and underrun-sensitive interfaces being compromised.

It would be advantageous if multi-link cut-through scheduling could be managed in a way that promoted overall fairness between the links, while preventing underrun to underrun-sensitive links.

### SUMMARY OF THE INVENTION

The present invention describes a scheduler that manages a common datapath for multiple remote link interfaces using a minimum of buffering, while enabling multiple interfaces/channels to be transmitted in parallel (cut-through). Fairness is applied across the interfaces without regard to their underrun status, while ensuring that underrun-sensitive interfaces are given a higher priority during the transmission of particular packets, to eliminate underrun.

Accordingly, a cut-through method is provided for scheduling information in an information distribution device. The method receives a plurality of information streams. A master schedule is created to select messages from the information streams for transfer to a corresponding plurality of remote links. The messages (e.g., packets) may have either a fixed or variable length. The master schedule is responsible for managing a communication link overall maximum bandwidth, and a message bandwidth for each remote link. Concurrently, an underrun schedule is created to select segment rates for a first group of messages destined to corresponding first group of remote links, and manage the message segment rate for the first group of messages. For example, the first group of messages may be destined to remote links that are sensitive to underrun.

More explicitly, the master schedule is used to transmit an initial message segment from each of the messages. The underrun schedule transmits message segments from the first group of messages at a minimum segment rate, subsequent to the transmission of the initial segment. The master schedule is used for transmitting message segments from non-first group messages at a non-critical segment rate, in response to the communication link overall maximum bandwidth and the non-first group message bandwidths. Typically, the non-first group messages are destined to remote links not sensitive to message underrun.

Additional details of the above-described method and an information distribution device with a cut-through information scheduling system are presented below.

### BRIEF DESCRIPTION OF THE DRAWINGS

FIG. 1 is a schematic block diagram of an information distribution device with a cut-through system for scheduling information.

FIG. 2 is a diagram depicting an exemplary transmission sequence.

FIGS. 3A through 31 are diagrams depicting the transmission sequence of FIG. 2, with emphasis on the management of message bandwidth.

FIG. 4 is a schematic block diagram depicting another exemplary transmission sequence.

FIG. 5 is a schematic block diagram depicting an alternate representation of the scheduling system of FIG. 1.

FIG. 6 is a flowchart illustrating a cut-through method for scheduling information in an information distribution device.

### DETAILED DESCRIPTION

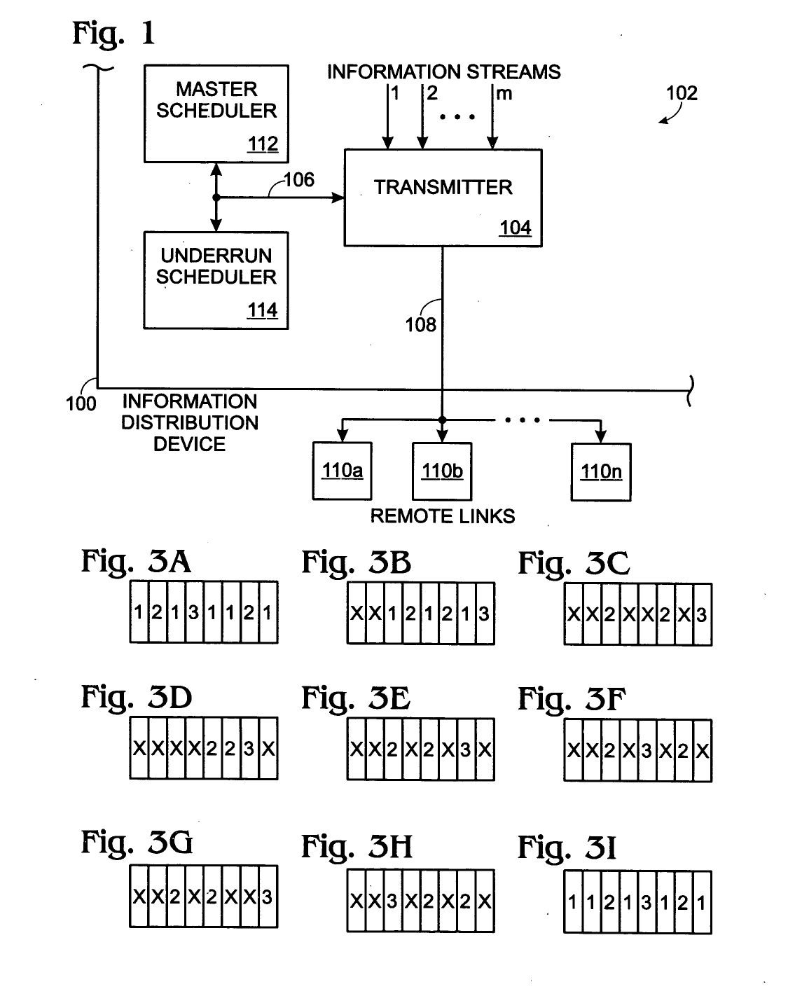

FIG. 1 is a schematic block diagram of an information distribution device 100 with a cut-through system for scheduling information. The system 102 comprises a transmitter 104 having an input on line to receive a plurality of information streams. Here, m information streams are shown, and m is not limited to any particular number. The transmitter 104 has a scheduling interface on line 106 to receive scheduling information, and a communication link output on line 108 to supply messages selected from the information streams, which are destined to remote links 110. Remote links 110a, 110b, and 110n are shown, but n is not limited to any particular number. Each message can either have a fixed or a variable length. For example, the messages may be referred to as packets or cells.

A master scheduler 112 has an output connected to the transmitter scheduling interface on line 106 to supply signals for selecting information streams. Scheduling interface 106 also supplies signals for managing the overall maximum bandwidth of the communication link 108, and for managing a message bandwidth for messages destined to each remote link. The remote links may a locally or network-connected external devices, and links may be internal to the information distribution device 100. An underrun scheduler 114 has an output connected to the transmitter scheduling interface on line 106 to supply signals for managing a segment rate for a first group of messages destined to a corresponding first group of remote links.

The master scheduler 112 schedules the transmission of an initial message segment from each of the messages. The underrun scheduler 114 schedules the transmission of message segments from the first group of messages, subsequent to the transmission of the initial segment. Once a message transmission is started, by transmitting the initial message segment, the underrun scheduler 114 is responsible for the transmission of the all of the following message segments in the message, if the message is a first group message.

For example, the underrun scheduler 114 may select a minimum segment rate for a first message destined for a first remote link (e.g., 110a) and schedule the transmission of message segments from the first message at a rate sufficient to meet the minimum segment rate. With respect to non-first group messages, which will be referred to herein as the second group of messages, the master scheduler 112 schedules the transmission of message segments from these second group messages at a non-critical segment rate, in response to the communication link overall maximum bandwidth and the second group message bandwidths.

That is, messages from both the first and second group of messages are scheduled by the master scheduler 112 at independent message bandwidths, which may be dependent upon the remote link receiving the message, within the constraints of the communication link (common datapath) overall maximum bandwidth. However, while the first group of messages are transmitted at a minimum segment rate (once the message is started), there is no special intra-message rate associated with second group messages. For example, the second group of messages may be destined to remote links that are not sensitive to message underrun.

In contrast, the underrun scheduler 114 may select minimum segment rates for messages destined to remote links that are sensitive to message underrun, for example, to remote links operating in accordance with Ethernet protocols. In one aspect, the underrun scheduler 114 schedules the transmission of message segments for the first group of messages to remote links operating a cut-through mechanism.

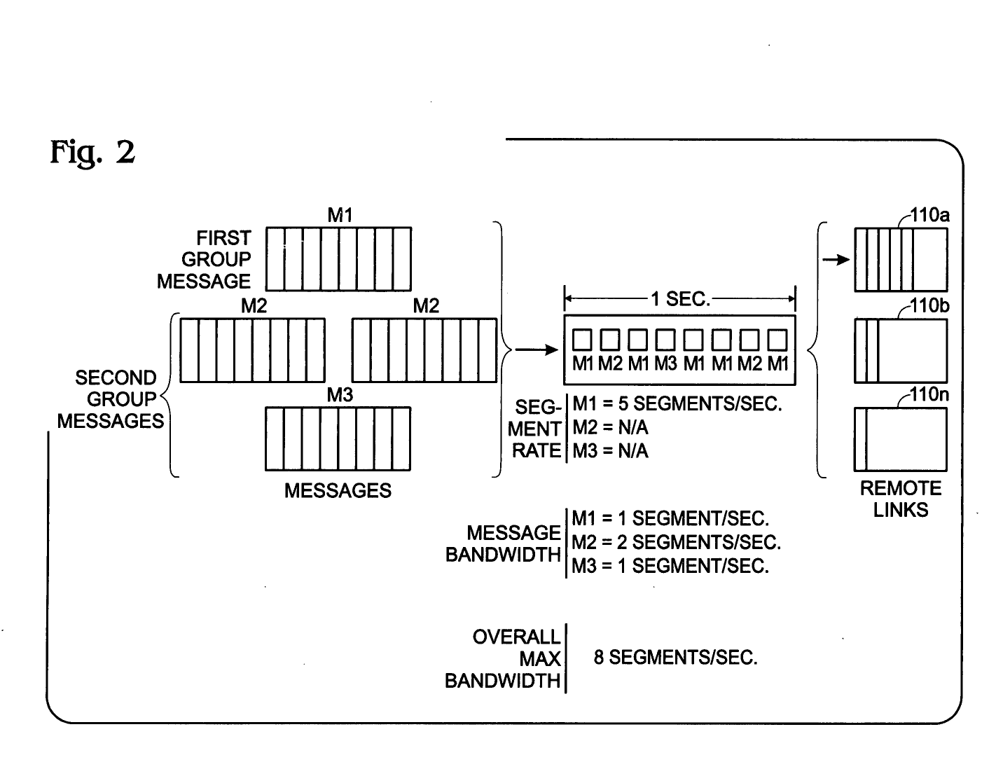

FIG. 2 is a diagram depicting an exemplary transmission sequence. Three messages are shown: first group message (M1) destined for remote link 110a, and two second group messages, M2 and M3, destined for remote links 110b and 110n, respectively. For simplicity, each message is shown as having the same length of 8 messages segments. The overall maximum bandwidth of the communication link between the information distribution device and the remote links is 8 segments per second. Again, this number is chosen for simplicity and it not necessarily an accurate reflection of practical communication rates. Although shown as a serial link, the communication link between the information distribution device and the remote links may also be organized as parallel connections. Due to constraints associated with the first remote links 110a, message segments from the first message M1 are scheduled by the underrun scheduler to be transmitted at a rate of 5 message segments per second. Messages M2 and M3 are not being scheduled in accordance with a message segment rate. All three of the messages have been assigned a message rate (bandwidth), which may be influenced by remote link constraints. Note: the message bandwidth associated with message M1 is only 1 message segment per second. As described in more detail below, the message bandwidth associated with messages destined to remote link 110a may be relatively slow, but once a message is started, the message segment rate may be considerable faster, to prevent underrun.

FIGS. 3A through 3I are diagrams depicting the transmission sequence of FIG. 2, with emphasis on the management of message bandwidth. FIG. 3A shows the same transmission sequence depicted in FIG. 2. Assuming that this sequence begins with the initial message segment from message M1, FIG. 3B shows the transmission of the final 3 message segments of the M1 message. Once the M1 message is transmitted, no message segments are sent from a subsequent M1 message (the next message destined to link 110a) until FIG. 3I. Thus, the overall M1 message bandwidth is 1 segment per second, even though the M1 message segment rate in the first 2 seconds (FIGS. 3A and 3B) is higher. Messages M2 and M3 are shown being managed at message rates of 2 segments and 1 segment per second, respectively. Assuming that the initial segment from message M2 is sent in FIG. 3A, segments from a second M2 message (the next message destined to remote link 110b) begin transmission in FIG. 3E, and segments from a third M2 message begin in FIG. 3I. The “x” symbols represent segments from other messages (e.g., M4 through Mm), which are not of interest to this discussion.

Returning to FIG. 1, the master scheduler 112 includes an interface on line 106 to receive transmitter backpressure information, which is indicative of the information segments being received by the remote links and the buffer level. Generally, this feedback information is used in the management of overall and messages bandwidths. For example, the backpressure information may be used to modify a message bandwidth in response to an unexpected change in the buffer status. Likewise, the information may be used in the selection of messages for transmission. Further, the master scheduler 112 receives underrun scheduler scheduling information. The master scheduler manages the communication link overall maximum bandwidth and the message bandwidth for each remote link in response to analyzing the underrun schedule management of the segment rates for the first group of messages. The underrun scheduler 114 also receives transmitter backpressure information on line 106, which is used in the management of the segment rates.

After the underrun scheduler 114 schedules the transmission of a final message segment from a first message associated with the first message group, to a first remote link (e.g., remote link 110a), the master scheduler 112 may select a second message destined to the first remote link. The transmission of the initial information segment of the second message is scheduled in response to the communication link overall maximum bandwidth and a second message bandwidth. Note: since the second message is destined to the first remote link 110a, the underrun scheduler is likely to select a minimum segment rate for the second message, after the initial segment from the message has been transmitted.

While the master scheduler 112 may select information streams, and messages from information streams, on the basis of fairness, in one aspect of the system 102 the master scheduler ranks the plurality of remote links 110a-110n and weights the selection of information streams in response to the remote link ranking. For example, the ranking may be based on quality of services associated with a remote link.

Functional Description

The above-described scheduling system supports segment interleaving of packet segments across a common datapath. This is a common technique to avoid transmission of large packets as continuous bursts across a combined datapath. The use of this technique improves quality of service, as high priority sources are not blocked by lower priority sources for the duration of a maximum packet size at the common datapath rate, although high priority sources may be blocked for a smaller segment size at the common datapath rate. This system also minimizes the buffering required at the line interfaces, as the segments for a packet are separated in time to provide an overall rate relative to the line interface rate. Unlike conventional systems, the entire packet being received at the higher common datapath rate need not be buffered to drain to the slower line interface rate.

The scheduling system supports line interfaces with a combined maximum bandwidth exceeding the common datapath bandwidth. It is common practice for line interfaces to be utilized for effective connectivity between end points where the sustainable bandwidth required across the interface is less than the link maximum bandwidth. For example, devices capable of processing proc_bw Gigabits of bandwidth may support (n×proc_bw) of Ethernet interface bandwidth, where n>1, as each interface carries a sustainable throughput of less than the maximum interface rate.

The scheduling system supports oversubscription to line interfaces sensitive to underrun. As mentioned above, while the sustainable interface bandwidth may be less than the peak bandwidth, protocols such as Ethernet require a packet be transferred across the link in a continuous burst at the peak bandwidth rate. Gaps in transmission result in the packet being dropped (failure to transfer the packet to the destination). Alternatively, channelized interfaces such as SPI3 or SPI4 can be utilized to send segments of a packet to remote devices which are operating with a cut-through mechanism, i.e., the remote devices do not wait for the entire packet to be received and buffered before starting transmission to the next stage. In this case, the packet can be transferred in segments across the interface to the device, however, the gaps between segments must be tightly controlled to prevent the attached device(s) from being starved of packet data to transmit before the packet has been completely transferred to the next stage. That is, the next stage must observe a continuous stream.

The scheduling system controls the commitment of total bandwidth to packets in mid-packet transmission to underrun sensitive line interfaces (to prevent underrun), while transmitting to as many line interfaces/channels in parallel as possible, to achieve maximum line interface utilization.

This transmission control provides for fairness across underrun and non-underrun sensitive interfaces. Interfaces not sensitive to underrun include connections across channelized interfaces (e.g., SPI3 and SPI4) to store-and-forward devices that buffer the entire packet before starting transmission of the start of the packet to the next stage. For these interfaces the gaps between segments of the packet is not critical. The scheduler, however, provides these interfaces with the required fairness (e.g., weight, rate). That is, non-underrun sensitive interface are treated the same as cut-through interfaces when considering sustainable (message) bandwidth requirements.

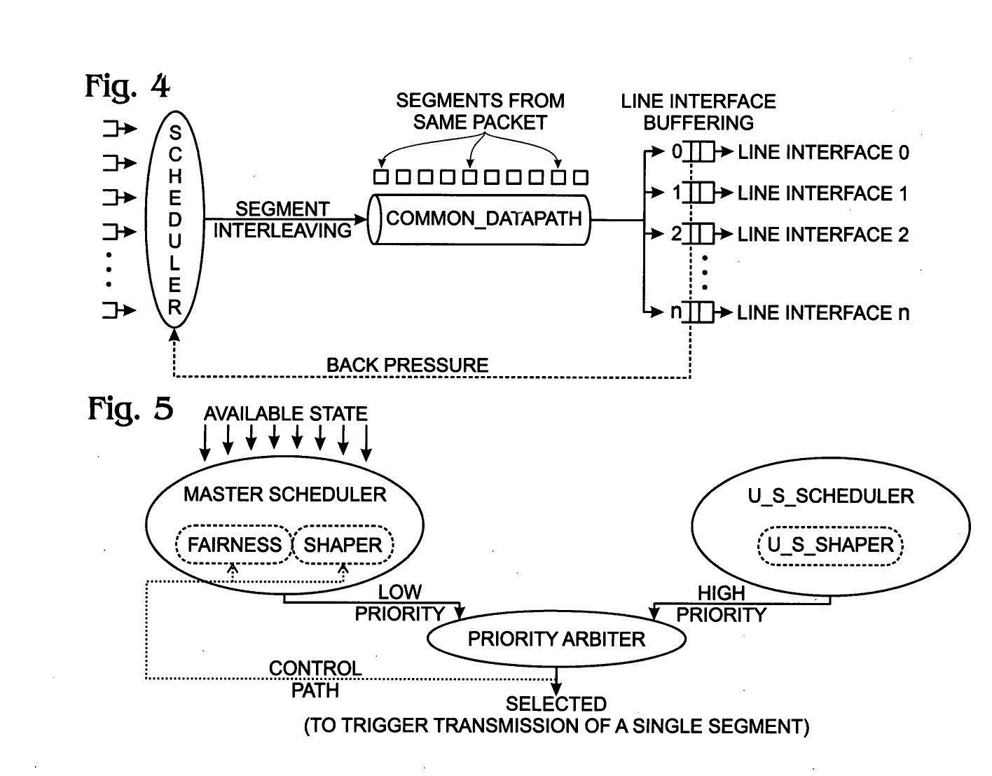

FIG. 4 is a schematic block diagram depicting another exemplary transmission sequence. The common datapath may be an internal datapath within a device, or may be a link between different devices. The line interfaces (remote links) need not buffer the entire packet prior to start of transmission to the line interfaces. The line interfaces may or may not be sensitive to underrun. The sum of line interface bandwidths may be greater than the common datapath bandwidth.

FIG. 5 is a schematic block diagram depicting an alternate representation of the scheduling system of FIG. 1. The system includes a scheduler with two distinct components, the master scheduler and the underrun (underrun-sensitive) scheduler (u_s_scheduler). The system selects from entities, e.g., queues of packets, which have a state indicating available to be transmitted, e.g., the queue contains at least 1 full packet. The system is the combination of multiple scheduler elements isolating the selection of entities feeding underrun sensitive line interfaces during packet transmission, while scheduling all entities from a master scheduler to meet their overall fairness and rate contracts. An entity feeding a line interface sensitive to underrun may have independent rate settings for the “shaper” and “u_s_shaper” mechanisms. These settings provide independent control over the required sustainable (target) rate (message bandwidth) and the segment rate (burst profile) for an entity during packet transmission to an underrun-sensitive link.

The master scheduler selects the first segment for all packets, and all segments for packets feeding non-underrun-sensitive line interfaces. The u_s_scheduler selects all segments, except the first segment, for packets feeding underrun-sensitive line.

The control path back to the schedulers is used for updating the scheduler working values, e.g., shaper tokens, weight, etc. The u_s_shaper working values are only updated when an entity is selected from the u_s_scheduler. The master scheduler working values are updated for all selected entities, regardless of whether they are selected from the master scheduler or the u_s_scheduler. The master scheduler maintains a credit mechanism covering the entities currently active within the u_s_scheduler. A sum of the u_s_shaper rates for these entities is maintained, and if this value exceeds the maximum permitted for the common datapath, no further entities feeding underrun-sensitive interfaces are selected by the master scheduler. This control prevents overbooking of the common datapath bandwidth to underrun-sensitive interfaces, thus preventing underrun.

Note: although the messages being delivered to the remote link interfaces have been referred to as packets, these messages are not limited to any particular structure and may also be referred to as cells, for example. Further, a cell may be considered as a packet with a fixed MTU size. The “fairness” and “shaper” elements within the master scheduler are examples of scheduling mechanisms. For example, “fairness” may refer to a scheduler mechanism used to allocate bandwidth to competing elements, e.g., a Weighted Round Robin (WRR) mechanism. A “shaper” refers to a scheduler mechanism that assigns a rate profile to an entity, e.g., sustainable rate or message bandwidth. The “u_s_shaper” may refer to a scheduler mechanism that assigns a rate profile to an entity, to prevent underrun of the line interface, e.g., a maximum rate. This rate profile is applied during packet transmission only.

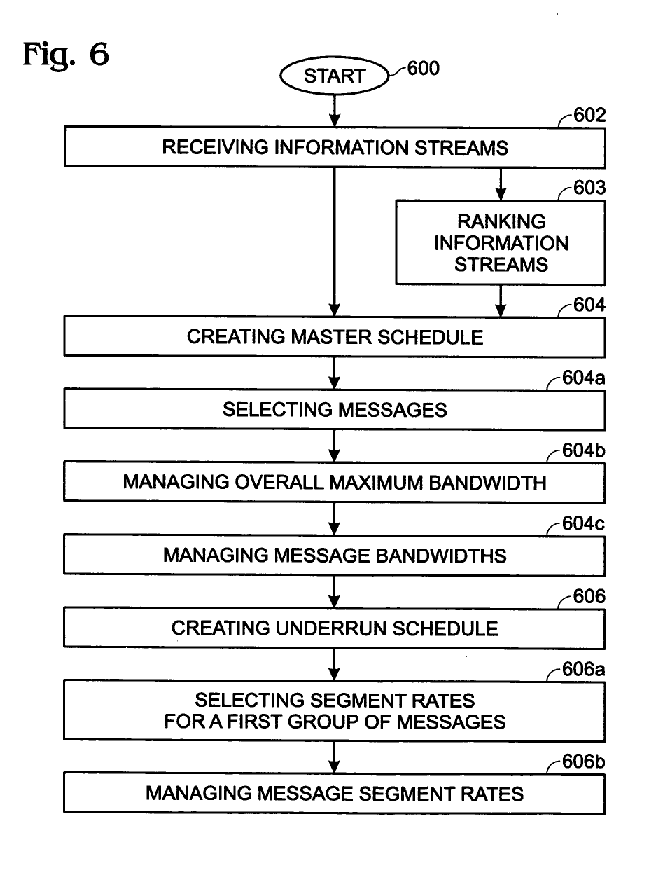

FIG. 6 is a flowchart illustrating a cut-through method for scheduling information in an information distribution device. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 600.

Step 602 receives a plurality of information streams. Step 604 creates a master schedule to select messages (Step 604a) from the information streams for transfer to a corresponding plurality of remote links, where each message has either a fixed or variable length. That is, the messages may be a combination of fixed and variable length messages. Step 604b manages a communication link overall maximum bandwidth, and Step 604c manages a communication link message bandwidth for each remote link. Step 606 creates an underrun schedule to select segment rates (Step 606a) for a first group of messages destined to corresponding first group of remote links. Step 606b manages a communication link message segment rate for the first group of messages. For example, the underrun schedule may manage the segment rate for a group of messages destined to remote links operating a cut-through mechanism.

In one aspect, creating the master schedule to manage the overall maximum bandwidth (Step 604b) and message bandwidths (Step 604c) includes managing the communication link overall maximum bandwidth and the message bandwidth for each remote link in response to analyzing the underrun schedule management of the segment rates for the first group of messages.

In another aspect, creating the master schedule to select messages from the information streams in Step 604a includes using the master schedule to transmit an initial message segment from each of the messages. Then creating the underrun schedule to manage the segment rate in Step 606b includes transmitting message segments from the first group of messages, subsequent to the transmission of the initial segment.

In another aspect, creating the underrun schedule to select the segment rate for the first group of messages in Step 606a includes selecting a minimum segment rate for a first message destined for a first remote link. Step 606b manages the transmission of message segments from the first message at a rate sufficient to meet the minimum segment rate. Typically, the minimum segment rate is selected for messages destined to a remote link sensitive to message underrun. For example, the underrun-sensitive interface may be a remote link operating in accordance with Ethernet protocols.

Creating the master schedule then further includes transmitting message segments from non-first group messages at a non-critical segment rate, in response to the communication link overall maximum bandwidth (Step 604b) and the non-first group message bandwidths (Step 604c). Typically, message segments from non-first group messages are transmitted at the non-critical segment rate to remote links not sensitive to message underrun.

In another aspect, Step 603 ranks the plurality of remote links. Then, the master schedule selecting messages for transfer to the remote links in Step 604a includes weighting the selection of information streams in response to the remote link ranking.

In a different aspect, creating the underrun schedule to manage the message segment rate in Step 606b includes completing the transmission of message segments from a first message to a first remote link. Then, creating the master schedule to select messages for transfer to remote links (Step 606a) includes selecting a second message destined to the first remote link, and transmitting the initial information segment of the second message in response to the communication link overall maximum bandwidth and a second message bandwidth.

A system and method of cut-through information scheduling have been presented, which maximize overall throughput, while maintaining an overall fairness and preventing underrun. Some examples of message formats, message sequences, and communication scenarios have been provided to illustrate the invention. However, the invention is not limited to merely these examples. Other variations and embodiments of the invention will occur to those skilled in the art.

We claim:

1. In an information distribution device, a cut-through method for scheduling information, the method comprising:
receiving a plurality of information streams;
creating a master schedule to:
select messages from the information streams for transfer to a corresponding plurality of remote links, where each message has a length chosen from a group consisting of fixed and variable length;
manage a communication link overall maximum bandwidth;
manage a communication link message bandwidth for each remote link; and,
creating an underrun schedule to:
select segment rates for a first group of messages destined to corresponding first group of remote links; and;
manage a communication link message segment rate for the first group of messages.

2. The method of claim 1 wherein creating the master schedule to select messages from the information streams includes using the master schedule to transmit an initial message segment from each of the messages; and,
wherein creating the underrun schedule to manage the segment rate includes transmitting message segments from the first group of messages, subsequent to the transmission of the initial segment.

3. The method of claim 1 wherein creating the underrun schedule to select the segment rate for the first group of messages includes selecting a minimum segment rate for a first message destined for a first remote link; and,
wherein managing a communication link message segment rate for the first group of messages includes managing the transmission of message segments from the first message at a rate sufficient to meet the minimum segment rate; and,
wherein creating the master schedule further includes transmitting message segments from non-first group messages at a non-critical segment rate, in response to the communication link overall maximum bandwidth and the non-first group message bandwidths.

4. The method of claim 3 wherein creating the master schedule to transmit message segments from non-first group messages at the non-critical segment rate includes transmitting the messages to remote links not sensitive to message underrun.

5. The method of claim 3 wherein creating the underrun schedule to select the minimum segment rate for the first message includes selecting a minimum segment rate for a first remote link sensitive to message underrun.

6. The method of claim 5 wherein creating the underrun schedule to select the minimum segment rate for the first remote link sensitive to message underrun includes selecting a segment rate for a first remote link operating in accordance with Ethernet protocols.

7. The method of claim 1 wherein creating the underrun schedule to manage the segment rate for the first group of messages includes transmitting message segments from the first group of messages to remote links operating a cut-through mechanism.

8. The method of claim 1 further comprising:
ranking the plurality of remote links; and,
wherein creating the master schedule to select messages for transfer to the remote links includes weighting the selection of information streams in response to the remote link ranking.

9. The method of claim 1 wherein creating the underrun schedule to manage the message segment rate includes completing the transmission of message segments from a first message destined to a first remote link; and,
wherein creating the master schedule to select messages for transfer to remote links further includes:
selecting a second message destined to the first remote link; and,
transmitting the initial information segment of the second message in response to the communication link overall maximum bandwidth and a second message bandwidth.

10. The method of claim 1 wherein creating the master schedule includes managing the communication link overall maximum bandwidth and the message bandwidth for each remote link in response to analyzing the underrun schedule management of the segment rates for the first group of messages.

11. In an information distribution device, a cut-through system for scheduling information, the system comprising:
a transmitter having an input to receive a plurality of information streams, a scheduling interface to receive scheduling information, and a communication link output to supply messages selected from the information streams and destined to remote links, where each message has a length chosen from a group consisting of fixed and variable length messages;
a master scheduler having an output connected to the transmitter scheduling interface to supply signals for selecting information streams, managing the communication link overall maximum bandwidth, and managing a message bandwidth for messages destined to each remote link; and,
an underrun scheduler having an output connected to the transmitter scheduling interface to supply signals for managing a segment rate for a first group of messages destined to a corresponding first group of remote links.

12. The system of claim 11 wherein the master scheduler schedules the transmission of an initial message segment from each of the messages; and,
wherein the underrun scheduler schedules the transmission of message segments from the first group of messages, subsequent to the transmission of the initial segment.

13. The system of claim 11 wherein the underrun scheduler selects a minimum segment rate for a first message destined for a first remote link and schedules the transmission of message segments from the first message at a rate sufficient to meet the minimum segment rate; and,
wherein the master scheduler schedules the transmission of message segments from non-first group message at a non-critical segment rate in response to the communication link overall maximum bandwidth and the non-first group message bandwidths.

14. The system of claim 13 wherein the master scheduler schedules the transmission of message segments from non-first group messages at the non-critical segment rate to remote links not sensitive to message underrun.

15. The system of claim 13 wherein the underrun scheduler selects a minimum segment rate for a first remote link sensitive to message underrun.

16. The system of claim 15 wherein the underrun scheduler selects the minimum segment rate for a first remote link operating in accordance with Ethernet protocols.

17. The system of claim 11 wherein the underrun scheduler schedules the transmission of message segments for the first group of messages to remote links operating a cut-through mechanism.

18. The system of claim 11 wherein the master scheduler ranks the plurality of remote links and weights the selection of information streams in response to the remote link ranking.

19. The system of claim 11 wherein the underrun scheduler schedules the transmission of a final message segment from a first message in the first group of messages, to a first remote link; and,
wherein the master scheduler selects a second message destined to the first remote link, and schedules the transmission of the initial information segment of the second message in response to the communication link overall maximum bandwidth and a second message bandwidth.

20. The system of claim 11 wherein the master scheduler includes an interface to receive transmitter backpressure information and underrun scheduler scheduling information, the master scheduler managing the communication link overall maximum bandwidth and the message bandwidth for each remote link in response to analyzing the underrun schedule management of the segment rates for the first group of messages.
